(19) United States
(12) Patent Application Publication
(10) Pub. No.: US 2002/0003167 A1
(43) Pub. Date: Jan. 10, 2002

(54) Mobile optical scanning device

(75) Inventor: Steven Cheng, Chung-Ho City (TW)

Correspondence Address: ROTHWELL, FIGG, ERNST & MANBECK, P.C., 555 13TH STREET, N.W., SUITE 701, EAST TOWER, WASHINGTON, DC, 20004, US

(73) Assignee: Dyna Data System Corporation

(21) Appl. No.: 09/891,529

(22) Filed: Jun. 27, 2001

(30) Foreign Application Priority Data
Jul. 4, 2000 (TW) 89113172

(51) Int. Cl. G06K 7/10

(52) U.S. Cl. 235/472.01

(57) ABSTRACT

A mobile optical scanning device is proposed, which includes a power supply module, a contact image sensor (CIS) module, an application specific integrated circuit (ASIC) and a memory module. The power supply module acts as a power source for the scanning device. The scanning process can be activated by inputting a signal to the ASIC for activating a driving unit of the CIS module for scanning. Analog data obtained from scanning are then converted to digital data by a signal processing unit of the CIS module, then allowing the digital data to be stored in the memory module. With the use of an input/output processing module of the ASIC being connected with an external host, the stored data in the memory module can be read. Since the scanning device is provided with the power source and memory, it can be used for scanning and storing data even in the condition of no hose being connected therewith.

### FIELD OF THE INVENTION

The present invention relates to mobile optical scanning devices, and more particularly, to a mobile optical scanning device which scans and stores data therein in the condition of no host being connected therewith.

### BACKGROUND OF THE INVENTION

In order to improve the quality of images or pictures commonly used in documents or publications e.g. posters, journals or flow charts, the images or pictures are generally collected and scanned into a computer by using an optical scanning device so as to achieve reality and easiness in edition for the images or pictures.

A widely used optical scanning device is a peripheral device associated with a personal digital assistant (PDA). As a result, the optical scanning device can not operate if not being connected with a host.

Therefore, how to make an optical scanning device operate in the condition that a host is unavailable, is a problem to solve. As such, the present invention proposes a mobile optical scanning device, which can be used in the absence of a host being connected therewith.

### SUMMARY OF THE INVENTION

The primary objective of the present invention is to provide a mobile optical scanning device which can scan data in the absence of a host being connected therewith. Moreover, the mobile optical scanning device can store the scanned data in the absence of the connected host. In addition, the mobile optical scanning device allows the data stored therein to be transmitted and processed in various host systems by means of an input/output processing module being provided in the mobile optical scanning device.

In accordance with the foregoing and other objectives of the invention, a mobile optical scanning device is proposed, which comprises a power supply module; a contact image sensor (CIS) module having a driving unit and a signal processing unit; an application specific integrated circuit (ASIC) having a controlling module, a memory processing module and an input/output processing module; and a memory module. The mobile optical scanning device of the invention contains a plurality of batteries acting as a power source, allowing convenience in carriage and in operation to be achieved for the scanning device. Further, the scanning device of the invention has the ASIC incorporated therein for controlling data and signal transmission between the modules of the scanning device. Moreover, the scanning device of the invention contains a plurality of memories, allowing image data to be stored therein in the condition of no host being connected with the scanning device. In addition, the scanning device of the invention has the input/output processing module, allowing digital data stored in the memory module to be transmitted and utilized in various external host systems.

First, a plurality of batteries are placed in the power supply module of the mobile optical scanning device of the invention so as to provide power for the scanning device. Then, the input/output processing module of the ASIC is inputted with a collecting signal for scanning, allowing the controlling module of the ASIC to generate a driving signal for scanning to the CIS module, so as to activate the driving unit of the CIS module for scanning images to be collected and converting the collected images into electric signals by means of the signal processing unit, i.e. converting analog signals to digital signals, and then digital data of the collected images in the form of the digital signals are inputted to the ASIC and transmitted to the memory module for storage. For reading out the digital data stored in the memory module, a read-out signal is inputted to the input/output processing module of the ASIC, which then withdraws the stored digital data from the memory module and outputs the data through the input/output processing module to various external host systems, allowing a user to edit the data.

### BRIEF DESCRIPTION OF THE DRAWINGS

The invention can be more fully understood by reading the following detailed description of the preferred embodiments, with reference made to the accompanying drawings, wherein:

FIG. 1 is a block diagram showing the basic structure of the mobile optical scanning device of the invention; and

FIG. 2 is a block diagram showing the connection between the mobile optical scanning device of the invention and a host.

### DETAILED DESCRIPTION OF THE PREFERRED EMBODIMENT

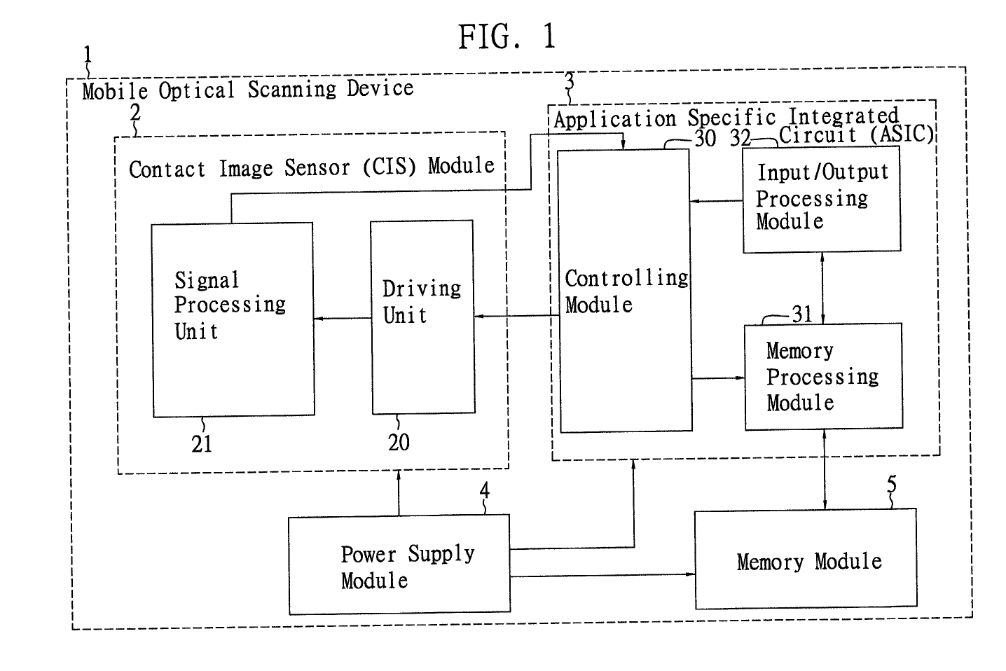

FIG. 1 is a block diagram illustrating the basic structure of the mobile optical scanning device of the invention. As shown in the drawing, the mobile optical scanning device 1 of the invention comprises a power supply module 4, a contact image sensor (CIS) module 2, an application specific integrated circuit (ASIC) 3 and a memory module 5.

The power supply module 4 is set with an installing portion (not shown) for placing a plurality of batteries therein, so as to provide power for the mobile optical scanning device 1.

The memory module 5 consists of DRAM, SRAM, flash memory and the like. During the scanning for images to be collected, the memory module 5 is used to store digital data converted from the collected images. Further, the memory module 5 can be set with a receiving portion (not shown) for memory replacement, that is, when the digital data to be stored are over the capacity of the current memory, the memory can be removed from the receiving portion and replaced by another memory having sufficient capacity, e.g. flash memory with a card structure, so as to complete the storage process. The card structure includes the flash memory card and smart medium card, wherein the flash memory card uses surface mounting technology to densely encapsulate the flash memory on a printed substrate, and the smart medium card is substantially thinner than the flash memory card in thickness. Since the card structure of the flash memory is a conventional skill, thus not to be described herewith.

The application specific integrated circuit (ASIC) 3 is a central processing unit of the mobile optical scanning device 1 of the invention, which comprises a controlling module 30, a memory processing module 31 and an input/output processing module 32. The controlling module 30 controls the transmission of the digital data between the memory processing module 31 and the input/output processing module 32. Further, control bus (not shown) is used to control the digital data transmission among the memory processing module 31, the memory module 5 and the input/output processing module 32. That is, data bus (not shown) of the foregoing three modules determines to write or read the data. The memory processing module 31 is provided with the data bus and address bus (not shown), which are connected with the memory module 5. The controlling module 30 controls the data transmission between the memory processing module 31 and the memory module 5 by the control bus (not shown) thereof, that is, the data bus controls and switches to writing the digital data converted from scanned data in the memory module 5 or reading the stored data in the memory module 5. The input/output processing module 32 comprises an input signal processing unit (not shown) and a peripheral interface processing unit (not shown), wherein the input signal processing unit allows a user to input a signal for scanning and storing an image or a signal for reading out a stored image, and the peripheral interface processing unit allows the stored digital data in the mobile optical scanning device 1 to be read in an external host. For scanning an image to be collected, the input signal processing unit of the input/output processing module 32 is inputted with a collecting signal for scanning, so as to activate the scanning process through the controlling module 30. In addition, for reading the digital data stored in the memory module 5, the input signal processing unit of the input/output processing module 32 is inputted with a reading signal, so as to activate the read process through the controlling module 30, and then the digital data are transmitted through the peripheral interface processing unit of the input/output processing module 32 to the external host system (not shown), allowing the user to edit the read data. Therefore, the ASIC 3 is used to determine if the user inputs a signal for scanning/storing or a signal for reading, and then the scanning/storing process or the read process are controlled and performed by the mobile optical scanning 1 device according to the input signal. The input signal processing unit has a keyboard or a switch, acting as communicating interface between the user and the mobile optical scanning device 1. The peripheral interface processing unit is connected with a data transmitting interface device, such as universal serial bus (USB), enhanced parallel port (EPP), serial port, personal computer memory card international association (PCMCIA) or IEEE 1394, provided in the external host system, e.g. desktop, notebook, iMAC or personal computer (PC). As such, the peripheral interface processing unit acts as data read-out interface between the mobile optical scanning device 1 and the external host system, allowing the user to select suitable data transmission interface according to the data transmitting speed or the operating environment.

The contact image sensor (CIS) module 2 comprises a driving unit 20 and a signal processing unit 21. The driving unit 20 connected with the controlling module 30 of the ASIC 3 proceeds scanning if receiving a driving signal for scanning from the controlling module 30. The driving unit 20 consists of mechanical and electronic devices, wherein a plurality of light-emitting diodes or optical elements e.g. light tubes arranged in a long line or rows are generally used as a light-emitting source (not shown). The light-emitting source is moved so as to irradiate an image to be collected, and a transducer is used to sense pixel data of the image and then transmit the pixel data to the signal processing unit 21. The signal processing unit 21 contains an analog to digital converter (ADC) for converting analog signals of the data to electric signals as voltage or current i.e. digital signals. During the signal conversion, since the input analog signals are varying, if the converting speed of the ADC can not catch up the varying speed of the signals, then a sampling and holding circuit (not shown) is used to obtain and store an instant value of the varying analog signals for subsequent analog conversion. However, when using the sampling and holding circuit, offset i.e. spike noise is generated overlapping the signals, and thus an operational amplifier (not shown) is applied for processing the offset. Further, during converting the pixel data to the electric signals, since a signal outputted from the transducer is usually smaller than 1 mV, an amplifier (not shown) is needed for amplifying the signal to a level to be easily processed Moreover, an input range for a general ADC is mostly −5V to +5V, or −10V to +10V; or a range of 0 to +5V or 0 to +10V is also applicable. If voltage of the signal is 0 to 10 mV, sufficiently accurate conversion can not be achieved by the ADC; if the signal voltage is out of the input range for the ADC, conversion can not be performed, and possibly damage to ADC is caused due to no proper protection for the ADC. As a result, in accordance with the input range for the ADC, the signal voltage must be processed by a voltage amplifier or a voltage reducer, i.e. an adjuster (not shown) for generating a proper signal voltage. Then, the digital signals processed by the ADC are transmitted to the controlling module 30 of the ASIC 3, and stored in the memory module 5 after being processing by the controlling module 30 and the memory processing module 31.

As a result, in the condition of the scanning device with no host being connected therewith, the mobile optical scanning device 1 of the invention can be used for scanning an image to be collected and storing the scanned image therein

In conclusion, first, a plurality of batteries are placed in the power supply module 4 of the mobile optical scanning device 1 of the invention so as to provide power for the scanning device 1. Then, the input/output processing module 32 of the ASIC 3 is inputted with a collecting signal for scanning, allowing the controlling module 30 of the ASIC 3 to generate a driving signal for scanning to the CIS module 2, so as to activate the driving unit of the CIS module 2 for scanning images to be collected and converting the collected images into electric signals by means of the signal processing unit 21, i.e. converting analog signals to digital signals, and then digital data of the collected images in the form of the digital signals are inputted to the ASIC 3 and transmitted to the memory module 5 for storage. For reading out the digital data stored in the memory module 5, a read-out signal is inputted to the input/output processing module of the ASIC 3, which then withdraws the stored digital data from the memory module 5 and outputs the data through the input/output processing module 32 to various external host systems, allowing a user to edit the data.

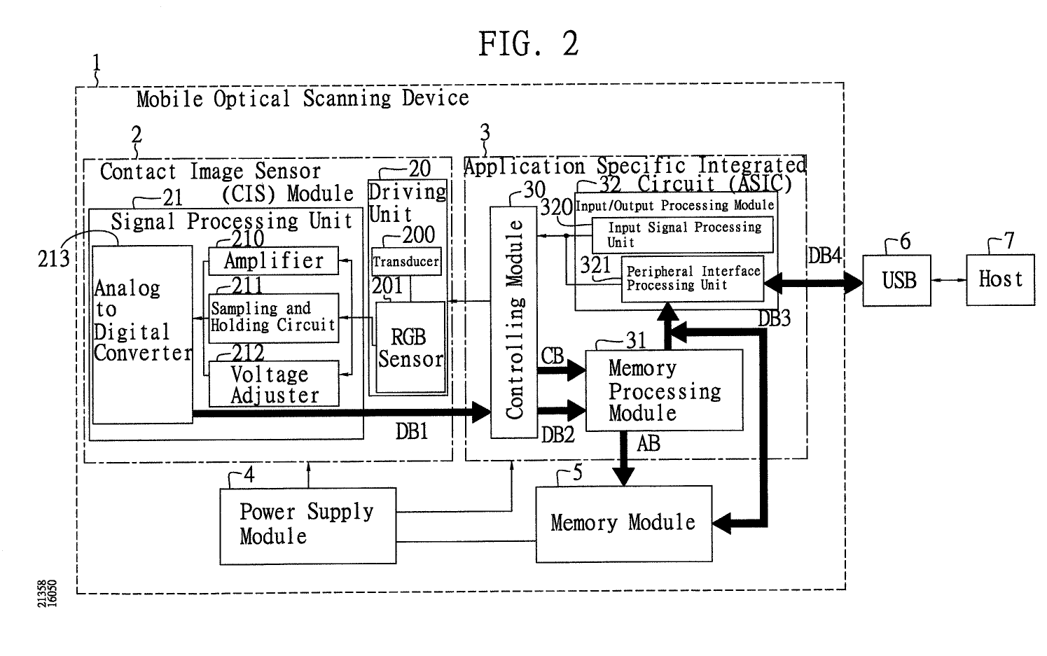

FIG. 2 is a block diagram showing the connection between the mobile optical scanning device of the invention and a host 7.

In the condition of no host being available for a scanning device, the mobile optical scanning device 1 of the invention can be applied.

First, a plurality of batteries placed in an installing portion (not shown) in the power supply module 4 of the mobile optical scanning device 1 act as a power supply. Then, for scanning, a scanning signal is inputted to an input signal processing unit 320 in the input/output processing module 32 of the ASIC 3. In the input signal processing unit 320 there can be provided a keyboard (not shown) or a switch (not shown), which acts as a communication medium between a user and the mobile optical scanning device 1. The inputted signal is then transmitted to the controlling module 30, so as to generate a driving signal and a scanning time series to the driving unit 20 of the CIS module 2. The driving unit 20 contains a transducer 200 and a red green blue (RGB) sensor 201. As such, an image collected by the transducer 200 is analyzed for its pixel components by the RGB sensor 201. Then, the pixel components are transmitted to the signal processing unit 21 of the CIS module 2. Since skills for sensing and analyzing are well known in arts, thus not to be described herewith.

Analog signals for the obtained pixel components are mostly smaller than 1 mV, and thus they are transmitted to an amplifier 210 for amplifying the signal to a level to be easily processed, and thus the amplified signals can be more accurately converted to digital signals in an analog to digital converter (ADC) 213 of the CIS module 2. Further, since the analog signals are always varying, a sample and holding circuit 211 is used to detect and store an instant value of the signal for subsequent conversion in the ADC 213. During applying the sample and holding circuit 211, offset is generated, and an operational amplifier is required for processing the offset. Moreover, if the output voltage of the converted signal is over the input range for the ADC 213, the conversion can not be achieved by the ADC 213, and further damage may be caused to the ADC 213 due to no sufficient protection for the ADC 213. As a result, according to the input range of the ADC 213, a voltage adjuster 212 is required for generating a proper signal voltage to be applied to the ADC 213.

The output signals of the pixel components obtained from the RGB sensor in the driving unit 20 are processed by the amplifier 210, the sample and holding circuit 211, and the voltage adjuster 212. The processed signals are transmitted and generate a analog time series (not shown) to the ADC 213, and then the processed signals are converted to digital data (i.e. 0 and 1), which are transmitted to the controlling module 30 by data bus DB1 in the ADC 213. At the mean time, control bus CB of the controlling module 30 sends a writing signal to the memory processing module 31, so as to activate data bus DB3 disposed between the memory processing module 31 and the memory module 5 for writing. As a result, after the controlling module 30 transmits the digital data through data bus DB2 to the memory processing module 31, the data bus DB3 further transmits the digital data to the memory module 5 for storage. In addition, when the data bus DB1, DB2 and DB3 share the same data bus, address bus AB in the memory processing module 31 and the control bus CB in the controlling module 30 can be used to process the digital data transmission among the ADC 213, the controlling module 30, the memory processing module 31 and the memory module 5.

For reading the data stored in the memory module 5, as shown in FIG. 2, a data transmitting interface device USB 6 is used and connected with the host 7 in the embodiment. First, an I/O port (not shown) of the host 7 is connected through the USB 6 with a peripheral interface processing unit 321 of the input/output processing module 32 in the mobile optical scanning device 1. Besides the USB 6, other data transmitting interface devices such as EPP, serial port, IEEE 1394 can be applied. Then, a signal for reading data is inputted to the input signal processing unit 320 of the input/output processing module 32, wherein the input signal processing unit 320 is provided with an input device such as a keyboard or a switch (not shown) for transmitting the input signal to the controlling module 30. The controlling module 30 then generates a reading signal to the memory processing module 31, and through the control bus CB allows the data bus DB3 between the memory processing module 31 and the memory module 5 to perform the reading process. That is, the stored data is transmitted first through the memory module 5 to the peripheral interface processing unit 321 of the input/output processing module 32, then through data bus DB4 of the peripheral interface processing unit 321 to the USB6, and then to the host 7, so as to show the data on a display (not shown) of the host 7 for edition.

In addition, since the peripheral interface processing unit 321 of the input/output processing module 32 is connected with the I/O port (not shown) of the host 7, for reading the data stored in the memory module 5, besides inputting a signal for reading data to the input signal processing unit 320, a peripheral input device such as a keyboard can be used for inputting the signal thereto. Then, the signal is transmitted through the USB6 to the peripheral interface processing unit 321, which then activates the controlling module 30 for reading the data stored in the memory module 5.

As concluded from the above-mentioned, the mobile optical scanning device proposed in the invention has the following advantages. First, the device is provided with a power source and memory, allowing scanning and storing data to be performed in the condition of no host being connected with the device. Moreover, the device can be used by being connected with various data transmitting interface devices, so that that device provides high compatibility to be applied in various host systems. In addition, the device is provided with a peripheral interface processing unit, allowing the data transmitting interface device to be selected according to transmitting speed for digital data or the operating environment.

The invention has been described using exemplary preferred embodiments. However, it is to be understood that the scope of the invention is not limited to the disclosed embodiments. On the contrary, it is intended to cover various modifications and similar arrangements. The scope of the claims, therefore, should be accorded the broadest interpretation so as to encompass all such modifications and similar arrangements.

What is claimed is:

1. A mobile optical scanning device, which comprises:
a power supply module for providing power for the mobile optical scanning device;
a contact image sensor module having a driving unit used for scanning collected images, and a signal processing unit used for converting analog signals of the images scanned by the driving unit into digital signals;
a memory module for storing digital data of the digital signals from the contact image sensor module; and
an application specific integrated circuit having:
an input/output processing module for transmitting data and signals among a user, the mobile optical scanning device and an external host;
a memory processing module for writing the digital data from the contact image sensor module to the memory module or reading the digital data stored in the memory module; and
a controlling module for driving the contact image sensor module to scan and for controlling the memory processing module to write or read.

2. The mobile optical scanning device of claim 1, wherein the input/output processing module of the application specific integrated circuit has an input signal processing unit used for allowing a user to input a scanning signal and a data reading signal thereto, and a peripheral interface processing unit connected with the external host for transmitting the digital data.

3. The mobile optical scanning device of claim 2, wherein the input signal processing unit has an input device e.g. a keyboard or a switch.

4. The mobile optical scanning device of claim 2, wherein the peripheral interface processing unit has a data connecting port connected with a data transmitting interface device of the external host.

5. The mobile optical scanning device of claim 2, wherein the external host is a desktop, notebook, iMAC or personal computer (PC).

6. The mobile optical scanning device of claim 4, wherein the data transmitting interface device of the external host is universal serial bus (USB), enhanced parallel port (EPP), serial port, personal computer memory card international association (PCMCIA) or IEEE 1394.

7. The mobile optical scanning device of claim 1, wherein the memory module consists of DRAM, SRAM or flash memory.

8. The mobile optical scanning device of claim 1, wherein the power supply module has an installing portion for placing batteries therein.

9. The mobile optical scanning device of claim 1, wherein the memory module has a receiving portion provided for replacing memory.

10. The mobile optical scanning device of claim 1, wherein the memory module has a receiving portion provided for replacing flash memory.

11. The mobile optical scanning device of claim 10, wherein the flash memory is a flash memory card.

12. The mobile optical scanning device of claim 10, wherein the flash memory is a smart medium card.
